(19) United States
(12) Patent Application Publication
(10) Pub. No.: US 2026/0219522 A1
(43) Pub. Date: Jul. 30, 2026

(54) HYBRID PLASMONIC ELECTRO-OPTIC MODULATORS

(71) Applicant: GlobalFoundries U.S. Inc., Malta, NY (US)

(72) Inventors: Avijit Chatterjee, Bangalore (IN); Aneesh Dash, Bangalore (IN); Pratyasha Priyadarshini, Bangalore (IN)

(21) Appl. No.: 19/079,538

(22) Filed: Mar. 14, 2025

(30) Foreign Application Priority Data
Jan. 24, 2025 (IN) 202511005863

(51) Int. Cl. G02F 1/01

(52) U.S. Cl. CPC G02F 1/011

(57) ABSTRACT

Structures for a photonic chip that include a modulator and methods of forming such structures. The structure comprises a first waveguide core, a second waveguide core that overlies the first waveguide core, and a first layer between the first waveguide core and the second waveguide core. The structure further comprises a second layer adjacent to the first layer, and a third layer adjacent to the first layer. The first layer is positioned in a lateral direction between the second layer and the third layer, the first layer comprises an electro-optic material, and the second and third layers comprise a metal.

### BACKGROUND

This disclosure relates to photonic chips and, more specifically, to structures for a photonic chip that include a modulator and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used in a modulator to modulate the phase of light propagating in a waveguide core. Phase shifters operating by an electro-optic mechanism or by a thermo-optic mechanism have the functionality to control the phase of the light through a change in the effective refractive index of the waveguide core.

Improved structures for a modulator and methods of forming such structures are needed.

### SUMMARY

In an embodiment of the invention, a structure for a photonic chip is provided. The structure comprises a first waveguide core, a second waveguide core that overlies the first waveguide core, and a first layer between the first waveguide core and the second waveguide core. The structure further comprises a second layer adjacent to the first layer, and a third layer adjacent to the first layer. The first layer is positioned in a lateral direction between the second layer and the third layer, the first layer comprises an electro-optic material, and the second and third layers comprise a metal.

In an embodiment of the invention, a method of forming a structure for a photonic chip is provided. The method comprises forming a first waveguide core, forming a first layer comprising an electro-optic material, and forming a second waveguide core that overlies the first waveguide core. The first layer is positioned between the first waveguide core and the second waveguide core. The method further comprises forming a second layer adjacent to the first layer, and forming a third layer adjacent to the first layer. The first layer is positioned in a lateral direction between the second layer and the third layer, and the second layer and the third layer comprise a metal.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a top view of the structure at a fabrication stage of the processing method subsequent to FIGS. 1, 1A.

FIG. 2A is a cross-sectional view taken generally along line 2A-2A in FIG. 2.

FIG. 3 is a cross-sectional view of the structure at a fabrication stage of the processing method subsequent to FIGS. 2, 2A.

FIG. 4 is a cross-sectional view of a structure in accordance with alternative embodiments of the invention.

FIG. 5 is a cross-sectional view of a structure in accordance with alternative embodiments of the invention.

FIG. 5A is a cross-sectional view of a structure in accordance with alternative embodiments of the invention.

FIG. 5B is a cross-sectional view of a structure in accordance with alternative embodiments of the invention.

FIG. 6 is a cross-sectional view of a structure in accordance with alternative embodiments of the invention.

FIG. 6A is a cross-sectional view of a structure in accordance with alternative embodiments of the invention.

FIG. 6B is a cross-sectional view of a structure in accordance with alternative embodiments of the invention.

FIG. 7 is a top view of a structure in accordance with alternative embodiments of the invention.

FIG. 8 is a top view of a structure in accordance with alternative embodiments of the invention.

### DETAILED DESCRIPTION

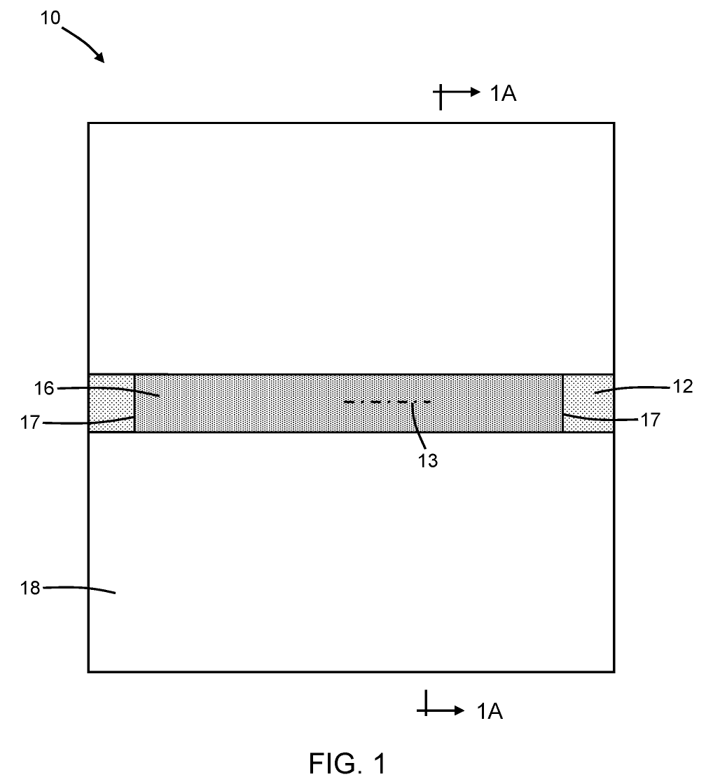

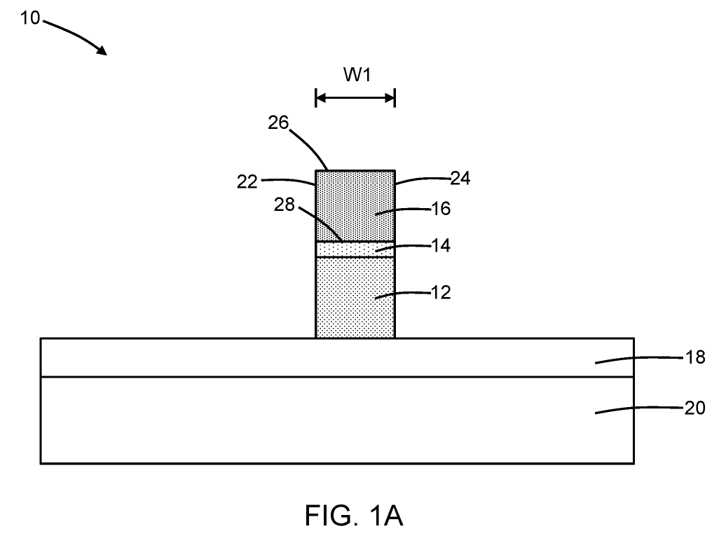

With reference to FIGS. 1, 1A and in accordance with embodiments of the invention, a structure 10 for a hybrid electro-optic modulator includes a waveguide core 12, a dielectric layer 14, and a layer 16 that overlies the waveguide core 12 in a vertical direction. The waveguide core 12, the dielectric layer 14, and the layer 16 are positioned on, and overlie, a dielectric layer 18 and a semiconductor substrate 20. In an embodiment, the dielectric layer 18 may be comprised of a dielectric material, such as silicon dioxide, and the semiconductor substrate 20 may be comprised of a semiconductor material, such as single-crystal silicon. In an embodiment, the dielectric layer 18 may be a buried oxide layer of a silicon-on-insulator substrate.

The waveguide core 12 includes a portion that is positioned in a vertical direction between the dielectric layer 18 and the dielectric layer 14. The dielectric layer 14 is positioned in a vertical direction between the layer 16 and the portion of the waveguide core 12. The dielectric layer 14 overlies, and overlaps, with the portion of the waveguide core 12. In an embodiment, the dielectric layer 14 may fully overlap with the portion of the waveguide core 12. A portion of the layer 16 overlies and overlaps with the dielectric layer 14 and the portion of the waveguide core 12. In an embodiment, the layer 16 may fully overlap with the dielectric layer 14 and the portion of the waveguide core 12. In an embodiment, the layer 16 may terminate at opposite ends 17, and the waveguide core 12 may have non-overlapped portions that extend past the opposite ends 17 of the layer 16.

In an embodiment, the waveguide core 12 may be comprised of a material having a refractive index that is greater than the refractive index of silicon dioxide. In an embodiment, the waveguide core 12 may be comprised of a semiconductor material, such as single-crystal silicon, amorphous silicon, or polysilicon. In an alternative embodiment, the waveguide core 12 may be comprised of a dielectric material, such as silicon nitride, silicon oxynitride, or aluminum nitride. In alternative embodiments, other materials, such as a III-V compound semiconductor, may be used to form the waveguide core 12. The dielectric layer 14 may be comprised of a dielectric material that is an electrical insulator. In an embodiment, the dielectric layer 14 may be comprised of silicon dioxide.

The layer 16 may be comprised of a material that exhibits tunable or dynamic photonic properties in response to an applied stimulus, such as an electric field. In an embodiment, the material constituting the layer 16 may be an electro-optic material that exhibits an electric-field-induced Pockels effect in which the refractive index varies in proportion to the strength of an applied stimulus, such as an electric field, according to a characteristic electro-optic coefficient. In an embodiment, the layer 16 may be comprised of a crystalline material that lacks inversion symmetry and that is characterized by an optic axis having a refractive index is controllable by an applied electric field. In an embodiment, the electro-optic material may be lithium niobate. In alternative embodiments, the electro-optic material may be lithium tantalate, lithium niobate doped with magnesium oxide, or barium titanate. In alternative embodiments, the electro-optic material may be a binary or ternary III-V compound semiconductor material, such as gallium nitride, indium gallium nitride, indium phosphide, indium gallium arsenide, gallium arsenide, indium arsenide, or indium gallium phosphide. In an alternative embodiment, the electro-optic material may be an electro-optic polymer.

The material constituting the waveguide core 12 and the material constituting the layer 16 may be characterized by different refractive indices. In an embodiment, the refractive index of the material constituting the waveguide core 12 may be greater than the refractive index of the material constituting the layer 16.

In an embodiment, the waveguide core 12, the dielectric layer 14, and the layer 16 may be formed by depositing a layer stack comprised of their respective constituent materials and patterning the layer stack with lithography and etching processes. In an embodiment, the waveguide core 12 may be formed from the semiconductor material (e.g., single-crystal silicon) of the device layer of a silicon-on-insulator substrate, and the materials of the dielectric layer 14 and the layer 16 may be deposited on the device layer prior to patterning.

The layer 16 has a sidewall 22, a sidewall 24 opposite from the sidewall 22, a top surface 26, and a bottom surface 28 opposite from the top surface 26. In an embodiment, the opposite sidewalls of the waveguide core 12 and the dielectric layer 14 may be aligned with the opposite sidewalls 22, 24 of the layer 16. The layer 16 have a width dimension W1 between the sidewall 22 and the sidewall 24. In an embodiment, the waveguide core 12 and the dielectric layer 14 may also have the width dimension W1. The layer 16 may extend lengthwise along a longitudinal axis 13. In an embodiment, the waveguide core 12 and the dielectric layer 14 may also extend lengthwise along respective longitudinal axes that are parallel to the longitudinal axis 13. The bottom surface 28 of the layer 16 may directly contact the dielectric layer 14 along an interface. The layer 16 may be fully surrounded by the sidewalls 22, 24, the top surface 26, and the bottom surface 28.

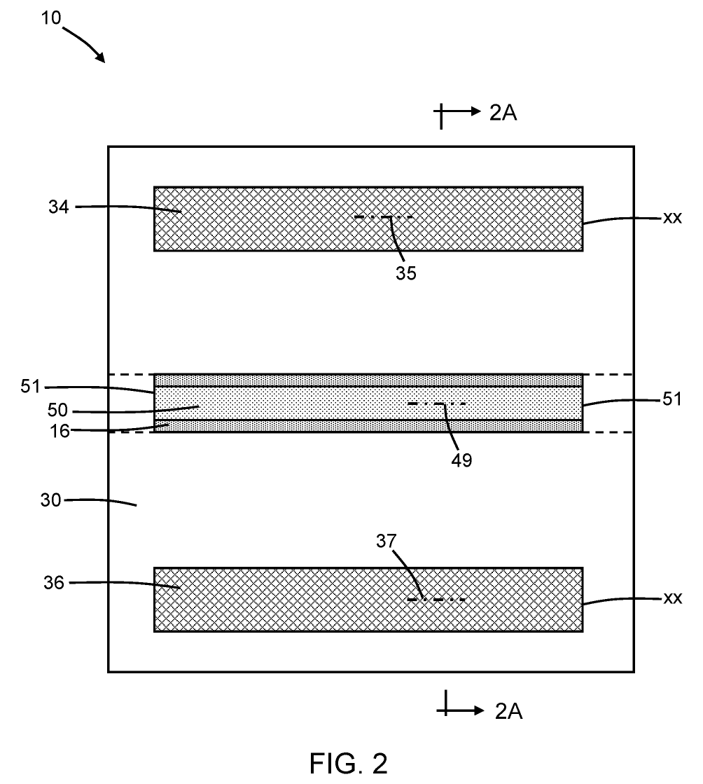

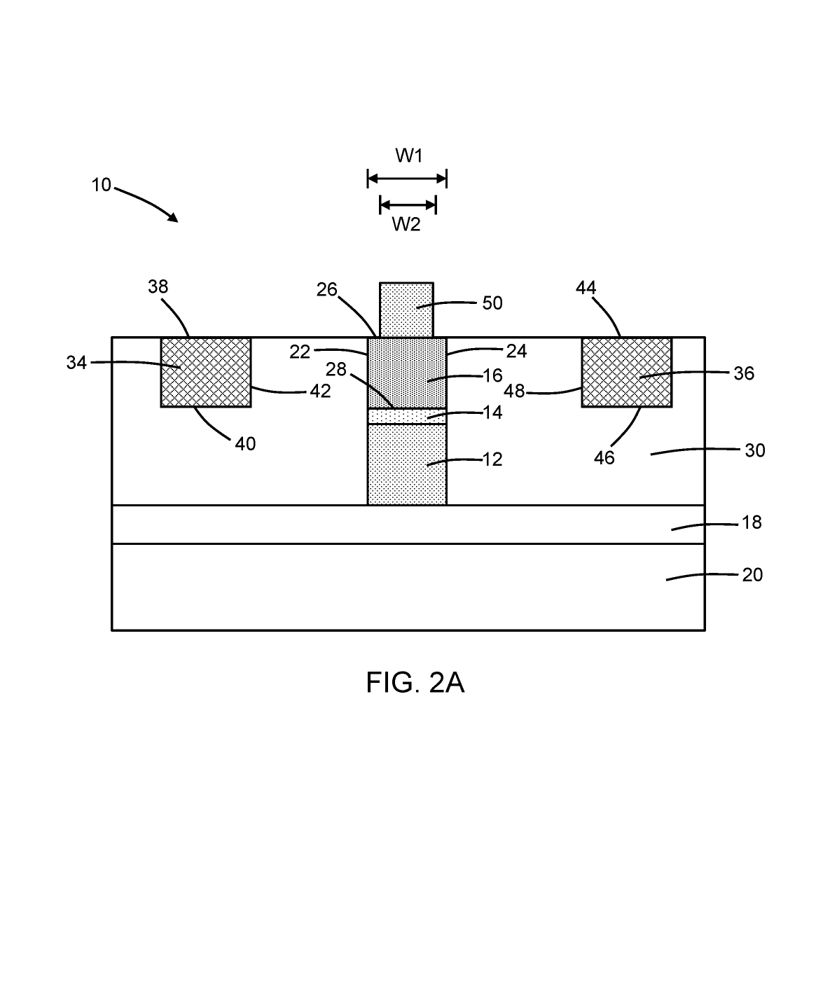

With reference to FIGS. 2, 2A in which like reference numerals refer to like features in FIGS. 1, 1A and at a subsequent fabrication stage, a dielectric layer 30 may be formed over the waveguide core 12, the dielectric layer 14, and the layer 16. The dielectric layer 30 may be comprised of a dielectric material, such as a silicon dioxide, having a refractive index that is less than the refractive index of the material constituting the waveguide core 12 and the layer 16. The dielectric layer 30 may be deposited and planarized to be coplanar with the top surface 26 of the layer 16.

A metal layer 34 and a metal layer 36 may be formed in the dielectric layer 30. The metal layers 34, 36 may be positioned in respective openings that are patterned in the dielectric layer 30 by lithography and etching processes. The metal layer 34 may have a longitudinal axis 35, the metal layer 36 may have a longitudinal axis 37, and the longitudinal axes 35, 37 may be aligned parallel to the longitudinal axis 13 of the layer 16. The layer 16 is laterally positioned between the metal layer 34 and the metal layer 36. The metal layer 34 is positioned with a lateral offset from the layer 16 and the metal layer 36 is also positioned with a lateral offset from the layer 16.

In an embodiment, the metal layers 34, 36 may be comprised of a metal, such as copper or aluminum, that is employed in back-end-of-line processing. In an alternative embodiment, the metal layers 34, 36 may be comprised of a noble metal, such as gold or silver.

The metal layer 34 has a top surface 38, a bottom surface 40 opposite from the top surface 38, and a sidewall 42 adjacent to the sidewall 22 of the layer 16. A portion of the dielectric layer 30 is positioned between the metal layer 34 and the dielectric layer 18. The metal layer 34 is laterally spaced from the layer 16 such that a portion of the dielectric layer 30 is positioned between the sidewall 42 of the metal layer 34 and the sidewall 22 of the layer 16.

In an embodiment, the top surface 38 of the metal layer 34 may be coplanar with the top surface 26 of the layer 16. In an embodiment, the bottom surface 40 of the metal layer 34 may be coplanar with the bottom surface 28 of the layer 16. In an embodiment, the metal layer 34 and the layer 16 may have equal thicknesses in which the top surface 38 of the metal layer 34 is coplanar with the top surface 26 of the layer 16 and the bottom surface 40 of the metal layer 34 is coplanar with the bottom surface 28 of the layer 16.

The metal layer 36 has a top surface 44, a bottom surface 46 opposite from the top surface 44, and a sidewall 48 adjacent to the sidewall 24 of the layer 16. The metal layer 36 is elevated above the dielectric layer 18 such that a portion of the dielectric layer 30 is positioned between the metal layer 36 and the dielectric layer 18. The metal layer 36 is laterally spaced from the layer 16 such that a portion of the dielectric layer 30 is positioned between the sidewall 48 of the metal layer 36 and the sidewall 24 of the layer 16.

In an embodiment, the top surface 44 of the metal layer 36 may be coplanar with the top surface 26 of the layer 16. In an embodiment, the bottom surface 46 of the metal layer 36 may be coplanar with the bottom surface 28 of the layer 16. In an embodiment, the metal layer 36 and the layer 16 may have equal thicknesses in which the top surface 44 of the metal layer 36 is coplanar with the top surface 26 of the layer 16 and the bottom surface 46 of the metal layer 36 is coplanar with the bottom surface 28 of the layer 16.

A waveguide core 50 may be formed on a portion of the top surface 26 of the layer 16. In an embodiment, the waveguide core 50 may be positioned fully above the top surface 26 of the layer 16. In an embodiment, the waveguide core 50 may be positioned fully above the top surface 38 of the metal layer 34 and fully above the top surface 44 of the metal layer 36. In an embodiment, the waveguide core 50 may have a width dimension W2 that is less than the width dimension W1. In an embodiment, the waveguide core 50 may directly contact the overlapped portion of the top surface 26 of the layer 16. The waveguide core 12, the dielectric layer 14, the layer 16, and the waveguide core 50 are positioned in a lateral direction between the metal layer 34 and the metal layer 36.

The waveguide core 50 may have a longitudinal axis 49 that is aligned parallel to the longitudinal axes 35, 37 of the metal layers 34, 36 and/or parallel to the longitudinal axis 13 of the layer 16. In an embodiment, the waveguide core 50 may terminate at opposite ends 51, and the waveguide core 12 may have non-overlapped portions that extend past the opposite ends 51 of the waveguide core 50. In an embodiment, the opposite ends 51 of the waveguide core 50 may be aligned with the opposite ends 17 of the layer 16.

In an embodiment, the waveguide core 50 may be comprised of a material having a refractive index that is greater than the refractive index of silicon dioxide. In an embodiment, the waveguide core 12 may be comprised of a dielectric material, such as silicon nitride, silicon oxynitride, or aluminum nitride. In an alternative embodiment, the waveguide core 50 may be comprised of a semiconductor material, such as amorphous silicon or polysilicon. In alternative embodiments, other materials, such as a III-V compound semiconductor, may be used to form the waveguide core 12.

In an embodiment, the waveguide core 50 may be formed by patterning a layer comprised of its constituent material with lithography and etching processes. In an embodiment, the layer may be deposited, an etch mask may be formed by a lithography process over the layer, and unmasked sections of the layer may be etched and removed with an etching process.

In an embodiment, the material constituting the waveguide core 50 and the material constituting the layer 16 may be characterized by different refractive indices. In an embodiment, the refractive index of the material constituting the waveguide core 50 may be greater than the refractive index of the material constituting the layer 16. In an embodiment, the material constituting the waveguide core 50 and the material constituting the waveguide core 12 may be characterized by different refractive indices.

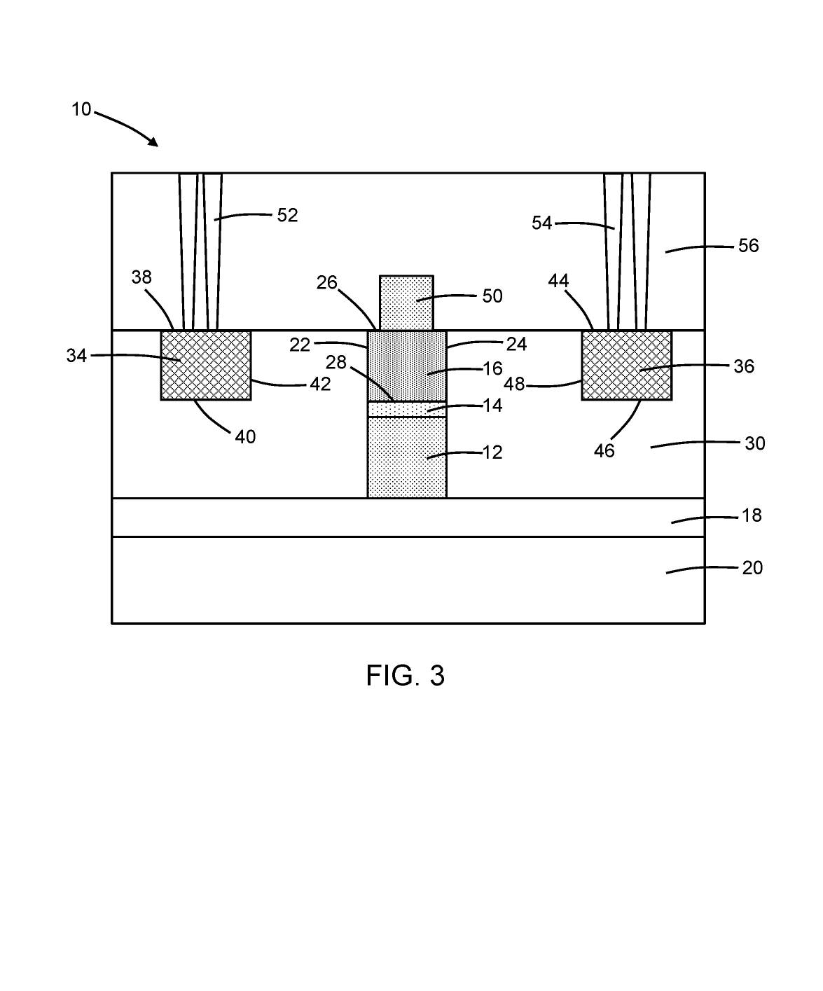

With reference to FIG. 3 in which like reference numerals refer to like features in FIGS. 2, 2A and at a subsequent fabrication stage, contacts 52, 54 may be formed in a dielectric layer 56 that are respectively coupled to the metal layers 34, 36. The contacts 52, 54 may be comprised of a metal, such as tungsten, and the dielectric layer 56 may be comprised of an electrical insulator, such as silicon dioxide. In an embodiment, the metal layers 34, 36 and the contacts 52, 54 may be used to apply a modulated electric field to the layer 16 that causes the refractive index of its material to vary in proportional to the strength of the applied electric field according to an electro-optic coefficient characterizing the material. The variation in the refractive index of the electro-optic material of the layer 16 may be used to modulate propagating light being guided by the waveguide core 12. For example, the modulated electric field may be used to generate a binary optical data stream.

The electro-optic modulator embodied in the structure 10, which may be deployed in a photonic integrated circuit on a photonic chip, includes the layer 16 of electro-optic material that is sandwiched between the passive waveguide core 12 and the passive waveguide core 50 to form a slot in which the layer 16 is positioned between the waveguide core 50 and the waveguide core 12. The slot between the waveguide core 50 and the waveguide core 12 provides a slot effect that assists with the confinement of propagating light in proximity to the layer 16. The metal layers 34, 36 provide electrodes that are located at an elevation adjacent to only the electro-optic material of the layer 16. The metal layers 34, 36 assist with the confinement of the propagating light proximate to the layer 16 through a plasmonic effect. Plasmonic and slot effects may be simultaneously excited when the hybrid electro-optic modulator is operating.

The hybrid electro-optic modulator embodied in the structure 10 permits optical confinement and electric field to be independently controlled. The hybrid electro-optic modulator embodied in the structure 10 may be characterized by a lower modulator figure of merit (VπLα) and a higher electro-optic bandwidth compared to a conventional electro-optic modulator that relies on a silicon p-n junction phase shifter.

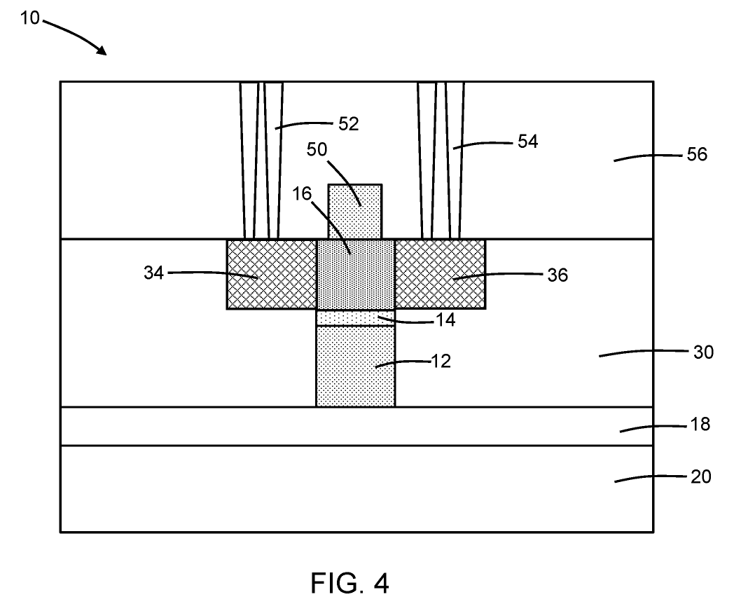

With reference to FIG. 4 and in accordance with alternative embodiments, the metal layers 34, 36 may be shifted laterally closer to the layer 16. In an embodiment and with additional reference to FIG. 3, the sidewall 42 of the metal layer 34 may directly contact (i.e., touch) the sidewall 22 of the layer 16, and/or the sidewall 48 of the metal layer 36 may directly contact (i.e., touch) the sidewall 24 of the layer 16.

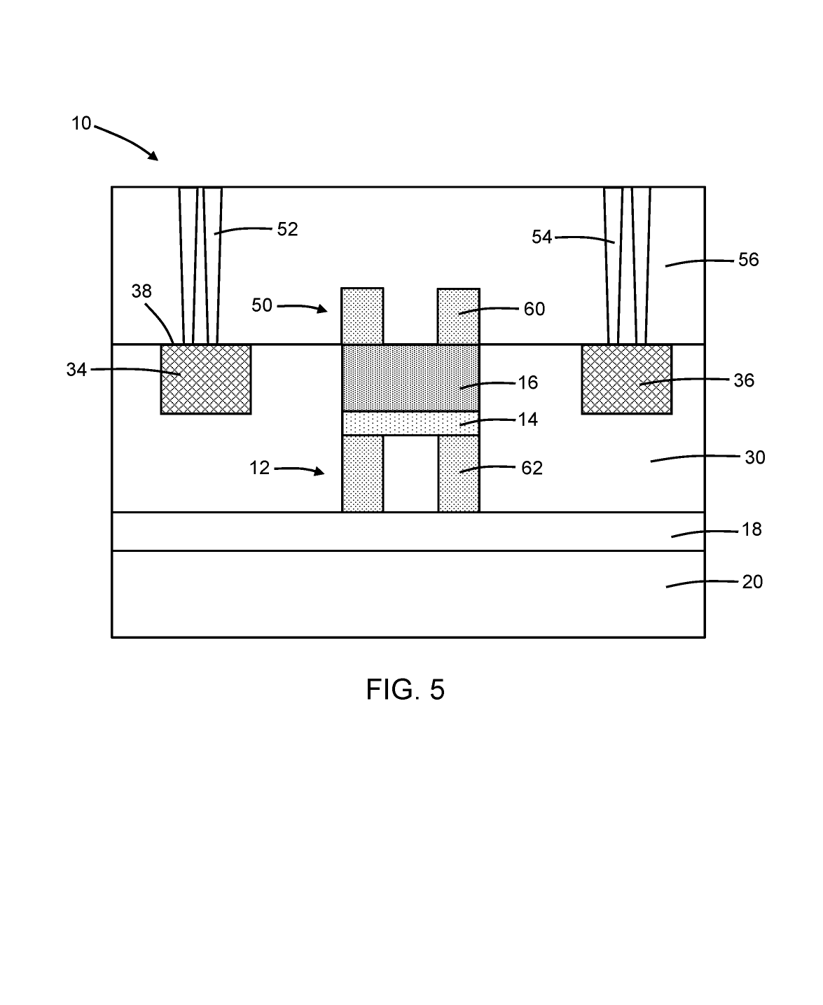

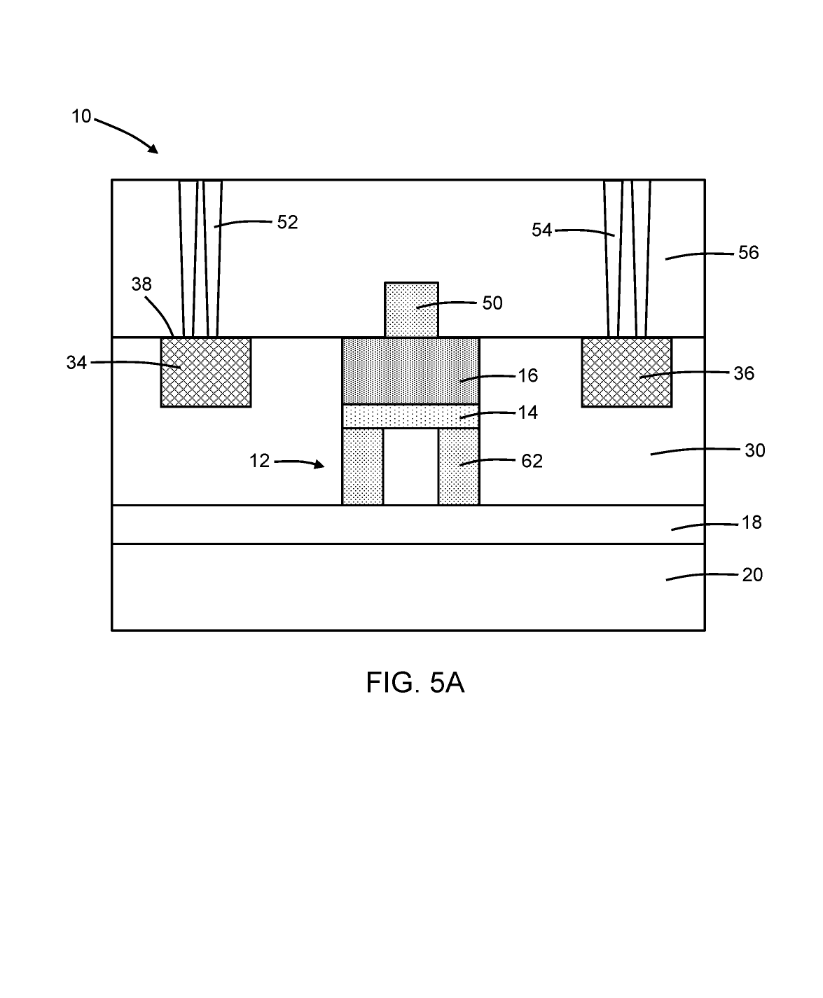

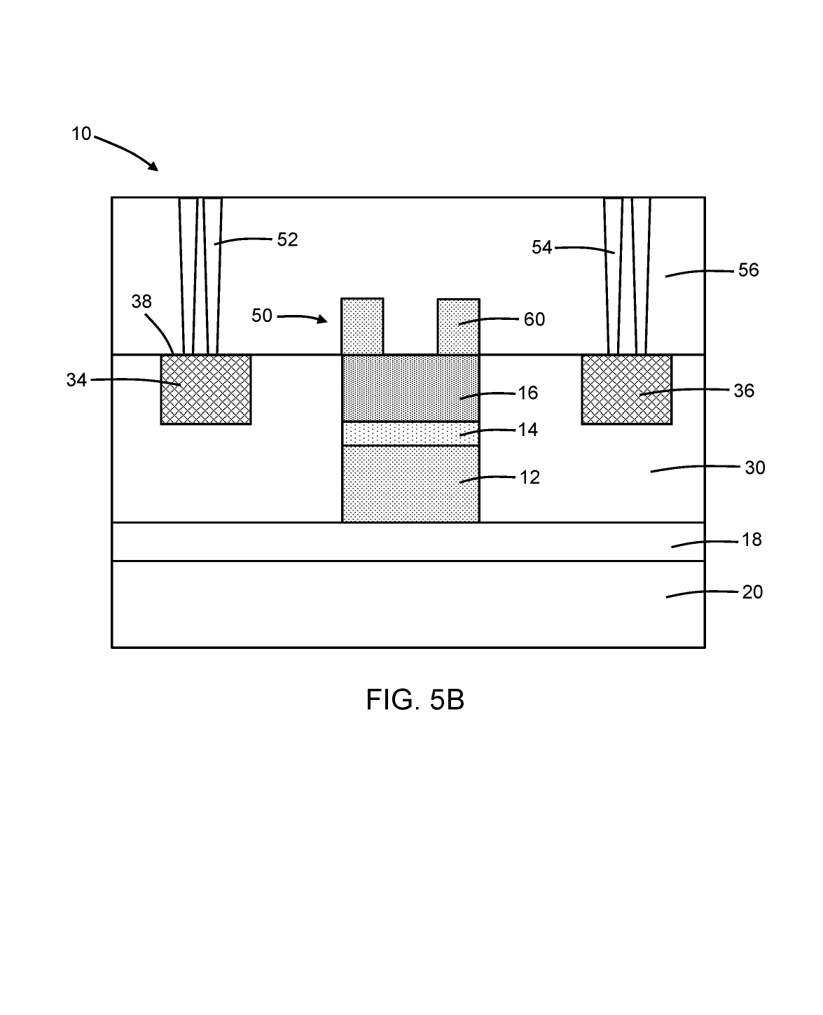

With reference to FIGS. 5, 5A, 5B and in accordance with alternative embodiments, the waveguide core 50 may be segmented into multiple segments 60, and the waveguide core 12 may also be segmented into multiple segments 62. Each of the segments 60 is positioned on a portion of the layer 16. Each of the segments 62 is positioned on a portion of the dielectric layer 18. In an embodiment, the waveguide core 50 may be segmented into a pair of segments 60. The layer 16 may provide a bridge between the segments 60 to the segments 62. In an embodiment, the waveguide core 12 may be segmented into a pair of segments 62. In an alternative embodiment, the waveguide core 12 may be segmented into more than a pair of segments 62. In an embodiment, the number of segments 62 may be equal to the number of segments 60. In an embodiment, the number of segments 62 may be greater than the number of segments 60.

In an alternative embodiment and as shown in FIG. 5A, the waveguide core 12 may be segmented into the segments 62, and the waveguide core 50 may be non-segmented. In an alternative embodiment and as shown in FIG. 5B, the waveguide core 50 may be segmented into the segments 60, and the waveguide core 12 may be non-segmented.

Segmenting the waveguide core 12 and/or the waveguide core 50 may improve mode matching and wavelength selectivity/filtering.

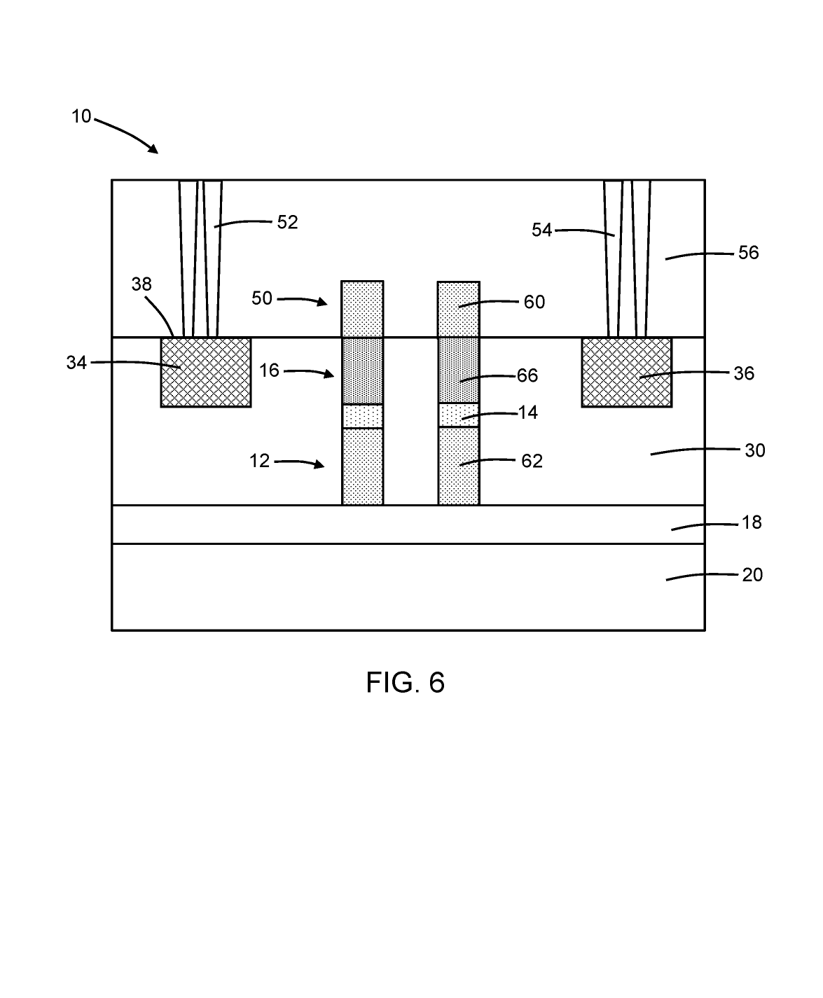

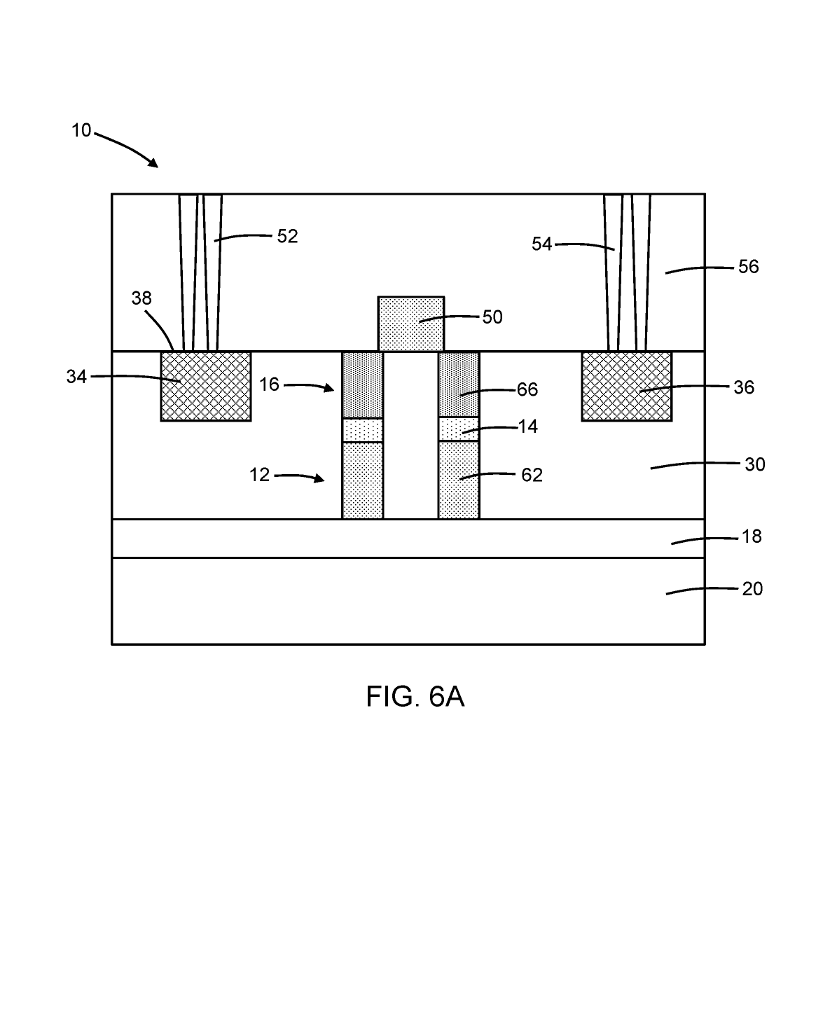

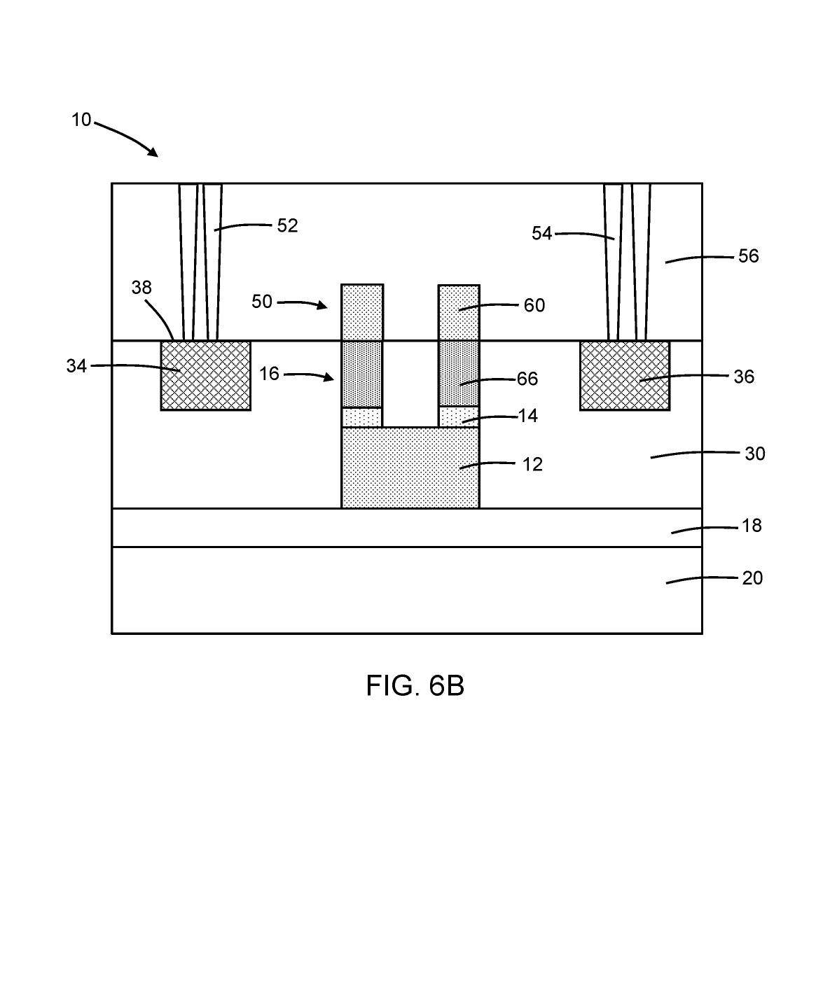

With reference to FIGS. 6, 6A, 6B and in accordance with alternative embodiments, the layer 16 may be segmented into multiple segments 66. The segments 66 of the layer 16 may be sandwiched between the segments 60 of the waveguide core 50 and the segments 62 of the waveguide core 12. In an embodiment, the number of segments 66 may be equal to the number of segments 60 and equal to the number of segments 62.

In an alternative embodiment and as shown in FIG. 6A, the waveguide core 12 may be segmented into the segments 62, and the layer 16 and the waveguide core 50 may be non-segmented. In an alternative embodiment and as shown in FIG. 6B, the waveguide core 50 may be segmented into the segments 60, and the layer 16 and the waveguide core 12 may be non-segmented.

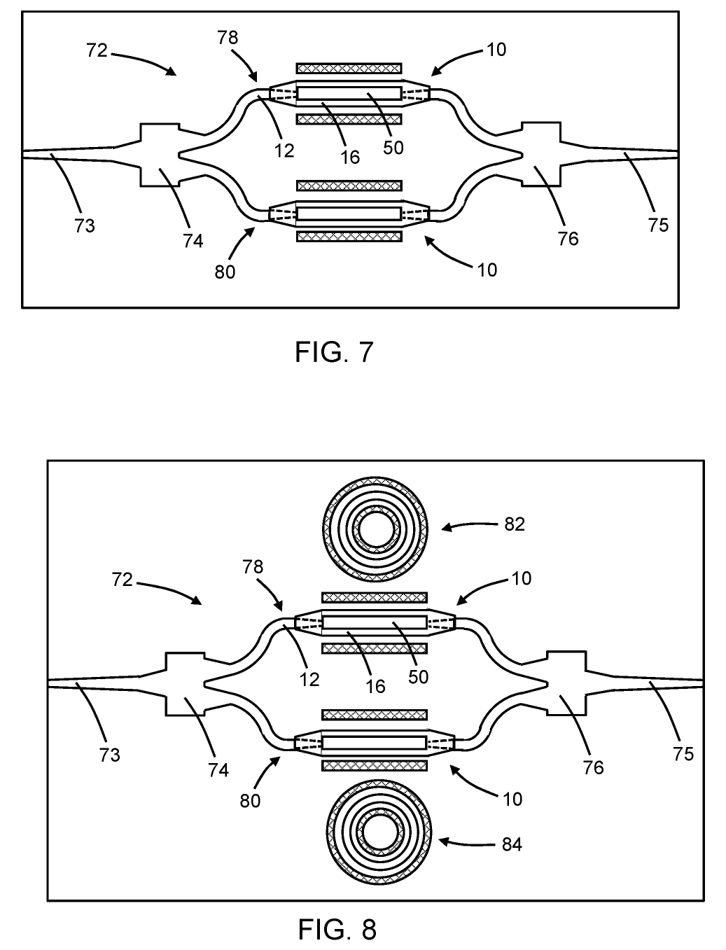

With reference to FIG. 7 and in accordance with alternative embodiments, a Mach-Zehnder modulator 72 includes an input optical coupler 74, an output optical coupler 76, and arms 78, 80 that are separately routed from the input optical coupler 74 to the output optical coupler 76. An input waveguide core 73 is coupled to the input optical coupler 74, and an output waveguide core 75 coupled to the output optical coupler 76.

Each of the arms 78, 80 of the Mach-Zehnder modulator 72 may include an instance of the waveguide core 12 and an instance of the hybrid electro-optic modulator embodied in the structure 10 that is integrated into a portion of the waveguide core 12. In that regard, the dielectric layer 14, the layer 16, and the waveguide core 50 are truncated and overlap the portion of the waveguide core 12 included in each of the arms 78, 80, and other non-overlapped portions of the waveguide core 12 in each of the arms 78, 80 couple the overlapped portion to the input optical coupler 74 and the output optical coupler 76. The layer 16 may include tapered sections at opposite ends that that overlap with tapered sections of the waveguide core 12.

The hybrid plasmonic waveguide structures may be used to generate a phase difference between the light propagating in the different arms 78, 80 of the Mach-Zehnder modulator 72 for generating a modulated light signal at the output optical coupler 76. The modulation may be achieved by applying an electrical signal to the electro-optic material of the layer 16 embedded in the different instances of the hybrid plasmonic modulator.

With reference to FIG. 8 and in accordance with alternative embodiments, a ring resonator 82 may be arranged adjacent to the instance of the hybrid electro-optic modulator integrated into the arm 78 of the Mach-Zehnder modulator 72, and a ring resonator 84 may be arranged adjacent to the instance of the hybrid electro-optic modulator integrated into the arm 80 of the Mach-Zehnder modulator 72. The ring resonators 82, 84 represent instances of the hybrid electro-optic modulator embodied in the structure 10 in which the ring resonators 82, 84 may have a closed round shape or, alternatively, a closed racetrack shape.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/- 10% of the stated value(s) or the stated condition(s).

References herein to terms such as “vertical”, “horizontal”, etc. are made by way of example, and not by way of limitation, to establish a frame of reference. The term “horizontal” as used herein is defined as a direction or a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “directly contacting” another feature if intervening features are absent. A feature may be “indirectly on” or in “indirect contact” with another feature if at least one intervening feature is present. A feature may “overlie” another feature if a feature is positioned “over” another feature. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a photonic chip, the structure comprising:
a first waveguide core;
a second waveguide core that overlies the first waveguide core;
a first layer between the first waveguide core and the second waveguide core, the first layer comprising an electro-optic material;
a second layer adjacent to the first layer; and
a third layer adjacent to the first layer,
wherein the first layer is positioned in a lateral direction between the second layer and the third layer, and the second layer and the third layer comprise a metal.

2. The structure of claim 1 wherein the second waveguide core is positioned on a portion of the first layer.

3. The structure of claim 1 wherein the second layer is in direct contact with the first layer, and the third layer is in direct contact with the first layer.

4. The structure of claim 1 wherein the first layer has a first surface and a second surface opposite from the first surface, the second layer has a first surface that is coplanar with the first surface of the first layer, and the second layer has a second surface that is coplanar with the second surface of the first layer.

5. The structure of claim 4 wherein the third layer has a first surface that is coplanar with the first surface of the first layer, and the third layer has a second surface that is coplanar with the second surface of the first layer.

6. The structure of claim 1 further comprising:
a semiconductor substrate; and
a dielectric layer on the semiconductor substrate,
wherein the first waveguide core and the first layer are positioned between the second waveguide core and the dielectric layer.

7. The structure of claim 6 wherein the first waveguide core includes a plurality of segments that are positioned between the first layer and the dielectric layer.

8. The structure of claim 6 wherein the second waveguide core includes a plurality of segments, and the first layer is positioned between the plurality of segments and the first waveguide core.

9. The structure of claim 6 wherein the first layer includes a plurality of segments positioned between the first waveguide core and the second waveguide core.

10. The structure of claim 1 wherein the electro-optic material is lithium niobate, lithium tantalate, lithium niobate doped with magnesium oxide, or barium titanate.

11. The structure of claim 10 wherein the metal is copper or aluminum.

12. The structure of claim 1 wherein the first waveguide core is comprised of a first material having a first refractive index, the second waveguide core is comprised of a second material having a second refractive index, the electro-optic material has a third refractive index, and the first refractive index is greater than the third refractive index.

13. The structure of claim 12 wherein the second refractive index is greater than the third refractive index.

14. The structure of claim 13 wherein the first refractive index differs from the second refractive index.

15. The structure of claim 1 wherein the first layer has an overlapping relationship with a portion of the first waveguide core.

16. The structure of claim 15 wherein the second waveguide core is positioned on a portion of the first layer.

17. The structure of claim 1 further comprising:
a first optical coupler; and
a second optical coupler,
wherein the first waveguide core extends from the first optical coupler to the second optical coupler, and the first layer and the second waveguide core overlap with a portion of the first waveguide core.

18. The structure of claim 17 further comprising:
a third waveguide core that extends from the first optical coupler to the second optical coupler.

19. The structure of claim 1 wherein the first waveguide core, the second waveguide core, the first layer, the second layer, and the third layer have a lengthwise parallel alignment.

20. A method of forming a structure for a photonic chip, the method comprising:
forming a first waveguide core;
forming a first layer comprising an electro-optic material;
forming a second waveguide core that overlies the first waveguide core, wherein the first layer is positioned between the first waveguide core and the second waveguide core;
forming a second layer adjacent to the first layer; and
forming a third layer adjacent to the first layer,
wherein the first layer is positioned in a lateral direction between the second layer and the third layer, and the second layer and the third layer comprise a metal.
